(19) United States
(12) Patent Application Publication
(10) Pub. No.: US 2007/0094904 A1
(43) Pub. Date: May 3, 2007

(54) Self-clinging, easily removed, marking sheet with indica

(76) Inventors: Valerie Frank, Bowden (CA); Michael Frank, Bowden (CA)

Correspondence Address: PATENT LAW & VENTURE GROUP, 2424 S.E. BRISTOL, SUITE 300, NEWPORT BEACH, CA, 92660, US

(21) Appl. No.: 11/263,812

(22) Filed: Oct. 31, 2005

(51) Int. Cl. G09F 7/12

(52) U.S. Cl. 40/594

(57) ABSTRACT

A marking apparatus comprising: a sheet of electrostatic-cling film, the sheet having a front surface, a rear surface and a peripheral edge. The front surface of the sheet is writable with a marker of the dry-erase type. There are a plurality of pinhole punctures uniformly distributed across the sheet. A tab is integral with the sheet and extends outwardly from the peripheral edge.

### RELATED APPLICATIONS

None

### BACKGROUND

1. Field of the Present Disclosure

This disclosure relates generally to instructional aids and more particularly to instructional aids having markable surfaces and utilizing electrostatic-cling adhesiveness.

2. Description of Related Art

Smith, et al., U.S. Pat. No. 6,866,516, discloses a dry erase panel assembly for use as a teaching aid including a first panel with a top edge, a bottom edge, a left edge, and a right edge. The first panel includes a writing section that is adapted to eraseably receive markings thereon. The panel assembly further includes a second panel with a top edge, a bottom edge, a left edge, a right edge, and a holding section. The second panel is secured to the first panel along the left edge and the right edge, whereby the holding section is spaced from the writing section to define a gap therebetween adapted to receive an information template. Austin, U.S. Pat. No. D496,689, discloses an ornamental design for a magnetic display board with transparent and label educational overlays, as shown and described. Lassoff, U.S. Pat. No. 5,655,323, discloses a message or note board that is also a holder for mail constructed of recycled plastic material and assembled from several different types of plastic but easily disassembled with common hand tools so that after final use, the parts may be segregated for further recycling. The noteboard has a flat plastic backing or plate that can be attached to a wall or a door on a refrigerator. Attached to the front surface is a transparent sheet that can be written on with a dry-erasable pen. A sheet of paper may be inserted between the transparent sheet and the backing plate and contains information. The lower end of the plate has an L-shaped tray or ledge that supports mail. Hance, U.S. Pat. No. 5,622,504, discloses a reusable bulletin board display for use in education. The reusable bulletin board display is trimmed to fit on conventional bulletin boards, or other similar surfaces, according to pre-marked indicators concentrically disposed about the border of the display, mounted on the conventional bulletin board by use of at least one attachment device, and set up and used according to the particular need. The reusable bulletin board display may also be used for promotional, exhibition or advertising purposes. When the reusable bulletin board display is no longer needed, it is dismounted from the conventional bulletin board, rolled up, placed in a storage device, and the storage device is labelled using the preferred method of identification. The storage device in which the reusable bulletin board display is received is then stored until needed once again. At that time, the reusable bulletin board display is simply retrieved, removed from the storage device and remounted. Reiter, U.S. Pat. No. 5,388,861, discloses a transparent overlay device for placement over printed material wherein notations can be made on the transparent overlay device over the printed material without leaving permanent markings on the printed material is disclosed. The transparent overlay device comprises: (a) a transparent sheet for substantially covering and protecting the printed material, the transparent sheet being capable of receiving notations thereon; (b) attachment means for removably attaching the transparent overlay device to the printed material without damaging the printed material; and (c) a notation border attached to the transparent sheet along at least one edge of the transparent sheet, the notation border being capable of receiving notations thereon without substantially blocking any of the printed material underlying the transparent sheet. Boyd, U.S. Pat. No. 5,207,581, discloses a writing apparatus including flexible electret film, capable of being erasably written upon with dry erase markers, as a writing medium. The apparatus includes a roll of electret film in a receptacle, brackets for mounting the receptacle to a wall or a conventional flip chart stand, and a cutter to separate the material into sheets. Concra, U.S. Pat. No. 5,110,295, discloses an educational training device in which a plurality of transparent sheets and base sheets are secured in fixed registry onto a top surface of a frame. A student can trace patterns shown on the base sheets onto the transparent sheets. The student can also remove and/or rearrange any of the sheets to thereby study the different interrelationships between the patterns. In addition, a top transparent sheet can be marked upon to draw a pattern that is extrapolated from the data provided by the underlying sheets. Stonehouse, U.S. Pat. No. 5,010,671, discloses a flip-chart comprising at least two sheets disposed in overlying relationship and releasably securable to one another by means of static cling, each said sheet adapted for writing thereon and erasure of said writing, and each said sheet being removeable from said other sheets for releasable securement to a surface soley by means of static cling. Baryla, U.S. Pat. No. 4,741,119, discloses a display board for displaying, behind a transparent window, a sheet document such as a paper document clinging electrostatically on the surface of a dielectric plastic backing board. The sheet document is covered by a sheet of transparent thin film plastic, preferably provided with a display window with a contrasting border or matte, which also tends to cling electrostatically against the sheet document with the result that the sheet document is sandwiched between the backing board and the sheet of transparent plastic film. Riehle, U.S. Pat. No. 4,250,642, discloses a planning aid produced by the use of a transparent foil which is adhesive on one side, thus providing a surface for the adhesion thereto of planning elements and/or symbols having smooth surfaces, the foil being applied to a sheet containing a pictorial representation. The planning elements and/or symbols may themselves be of foil structure or of plastic-coated cardboard or the like. For the purpose of providing a permanent record of the juxtaposition of the planning elements and/or symbols to the pictorial representation, the surface with said elements and/or symbols adhering thereto may be photocopied. Flood, U.S. Pat. No. 3,889,397, discloses a device for composing designs, characters, forms, and the like, utilizing a pad, a plurality of transparent sheets and tabs having imprinted segments of the design, character form, and the like. The tabs are interposed between the pad and sheets to combine the segments and to form the finished design, character, and the like, which are traceable with the tracing paper. Thomas, U.S. Pat. No. 3,768,177, discloses a multiple sheet composite amusement and educational instruction kit for both children and adults. One facet of the kit teaches and enables picture composition while another facet thereof serves to preliminarily educate a child or student in the basic numbers and letters of the alphabet. The subject composite kit provides amusement and education including both original sketching or doodling upon certain components of the kit, as well as cutting out and/or detaching component unit members and sticking them onto background boards or sheets to compose either artistic composite pictures or to learn the alphabet or numeral sequences. Nahon, U.S. Pat. No. 3,696,532, discloses a perpetual memo pad including a transparent sleeve formed of hinged sections and adapted to receive erasable indicia, and a card bearing permanent indicia and insertable into said transparent sleeve in a manner to align selected indicia on said card, said sleeve being rotatable relative to said card to bring other selected indicia on the sleeve into alignment with other selected indicia.

Our prior art search with abstracts described above teaches: instructional aids of several types. Thus, the prior art shows; dry-erase type marking surfaces; printed, transparent overlays; and electrostatic-cling sheets. However, the prior art fails to teach such an instructional aid that provides for improved removal and attachment with respect to a surface of application. The present disclosure distinguishes over the prior art by providing such so as to enable heretofore unknown advantages as described in the following summary.

### SUMMARY

This disclosure teaches certain benefits in construction and use which give rise to the objectives described below.

Cling plastic sheets are known, but, in use are difficult to peel away from a smooth surface. Such sheets are easily marked by certain inks and can be advantageously used in classroom teaching venues especially for small children. The present disclosure teaches a marking apparatus encompassing a sheet of electrostatic-cling film with a surface that is easily written upon using marker pens preferably of the dry-erase type so that the marks may be later removed and new marks applied. Such sheets may have indicia such a grid marks, lines boxes or other forms that guide or otherwise instruct or organize removable writings. The sheet has a plurality of uniformly distributed fine pinhole punctures which allow it to be more easily stripped from a surface that it adheres to, and a tab extending outwardly from a peripheral edge so as to easily peel the sheet from the surface.

A primary objective inherent in the above described apparatus and method of use is to provide advantages not taught by the prior art.

Another objective is to provide a reusable marking apparatus.

A further objective is to provide such an apparatus that can be pressed onto a surface without capturing air pockets.

A still further objective is to provide such an apparatus having a means of for easily stripping the apparatus from a surface to which it is adhered.

Other features and advantages of the described apparatus and method of use will become apparent from the following more detailed description, taken in conjunction with the accompanying drawings, which illustrate, by way of example, the principles of the presently described apparatus and method of its use.

### BRIEF DESCRIPTION OF THE DRAWINGS

The accompanying drawings illustrate at least one of the best mode embodiments of the present apparatus and method of it use. In such drawings:

FIG. 1 is a perspective view of the apparatus as applied to a whiteboard or similar smooth surface; and

FIG. 2 is a front elevational view thereof;

FIG. 3 is a further perspective view of the apparatus showing pinholes thereof, the pinholes shown in exaggerated size;

FIG. 4 is a partial sectional view thereof taken along line 4-4 in FIG. 3 and showing an embodiment of the apparatus including a thin tab extending from an edge; and

FIG. 5 is a further partial sectional view thereof taken along line 4-4 in FIG. 3 and showing a full thickness tab extending from the edge, the tab being curled.

### DETAILED DESCRIPTION

The above described drawing figures illustrate the described apparatus and its method of use in at least one of its preferred, best mode embodiment, which is further defined in detail in the following description. Those having ordinary skill in the art may be able to make alterations and modifications what is described herein without departing from its spirit and scope. Therefore, it must be understood that what is illustrated is set forth only for the purposes of example and that it should not be taken as a limitation in the scope of the present apparatus and method of use.

A marking apparatus is comprised of a sheet 10 of electrostatic-cling film, or similar self-adhering material. As shown in FIG. 3, The sheet 10 includes a front surface 12, a rear surface 14 and a peripheral edge 16. The rear surface of the sheet is electrostatically adhered to an applied surface 50, as seen in FIGS. 3 and 4, so as to be removable from the applied surface 50. The sheet 10 includes a plurality of pinhole punctures 20, as shown in FIG. 3, which are uniformly distributed across the sheet 10 so as to prohibit the trapping of air pockets when adhering the sheet 10 to the applied surface 50 and also to enable the sheet 10 to be more easily removed when necessary or desired. The pinhole punctures 20 are preferably quite small; of between 0.0001 and 0.0005 inches in diameter and extend through the sheet 10 from its front surface 12 to its rear surface 14.

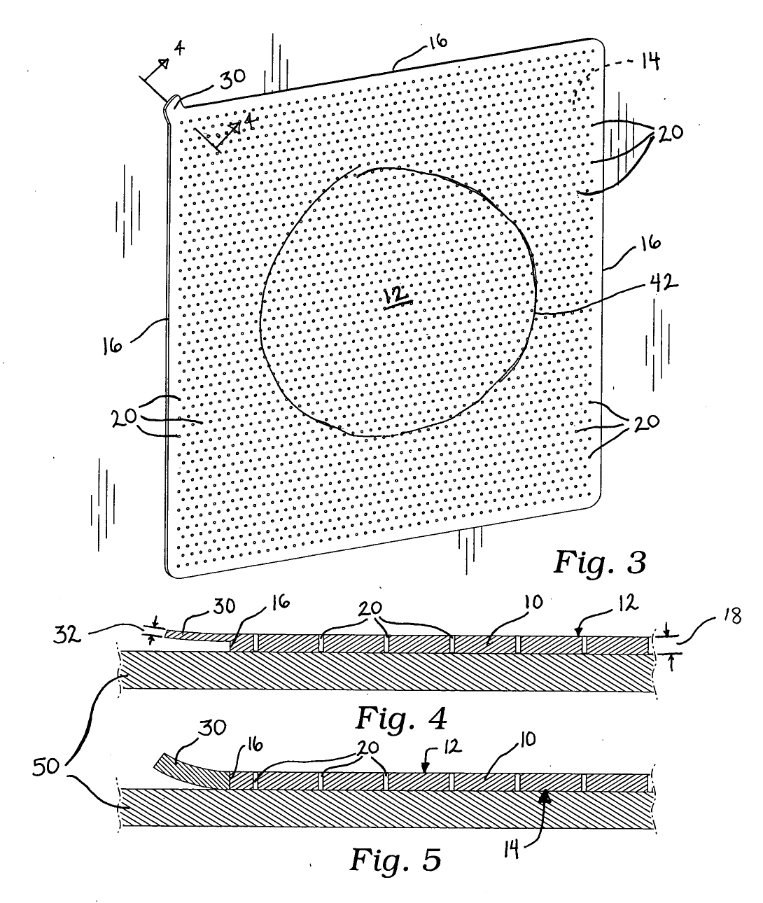

As shown in FIGS. 4 and 5, a tab 30, employed in the removal and application of the sheet 10 with respect to the applied surface 50, is integral with the sheet 10 and extends outwardly from the peripheral edge 16. In one embodiment of the present apparatus, shown in FIG. 4, the tab 30 has a tab thickness 32, which is lesser than a sheet thickness 18, so as to permit it to be more easily grasped. This tab 30 is preferably coplanar with the front surface 12 of the sheet 10 and in one embodiment, there exists a space between the tab 30 and the applied surface 50 such that the tab 30 is not in contact with the applied surface 50. In another embodiment, the tab 30 is formed so as to bend away from the rear surface 14 of the sheet 10, also preventing contact between the tab 30 and the applied surface 50 as best seen in FIG. 5.

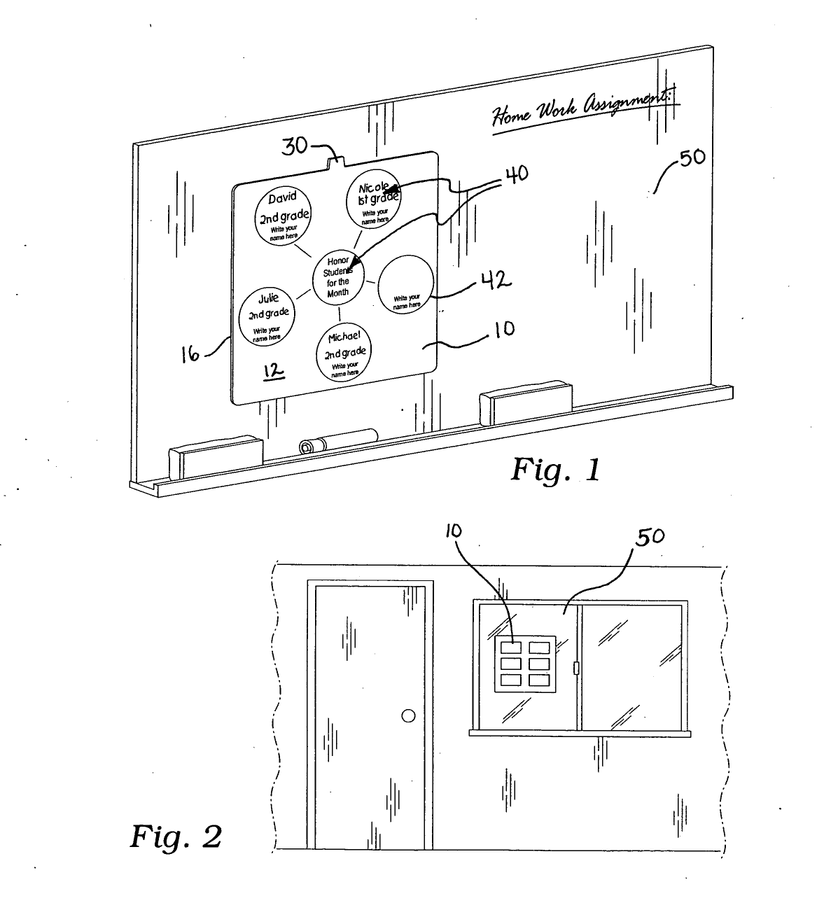

As shown in FIG. 1, the front surface 12 of the sheet 10 is preferably of a type that can be marked using an erasable marker ink 40, of the type available for writing upon a whiteboard. Also shown in FIG. 1, the front surface 12 of the sheet 10 preferably has an indicia 42, preferably of an educational or informative nature. The indicia 42 are permanently printed onto the front surface 12 of the sheet 10, preferably by the method of silk screening or another appropriate method that would be known to those of skill in the art. The indicia 42 is used as template framing of an informative nature, such as, but not limited to: bullet point schemes, pie-graphs, calendars, and brain storming charts.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

1. A marking apparatus comprising: a sheet of electrostatic-cling film, the sheet having a front surface, a rear surface and a peripheral edge, a plurality of pinhole punctures in the sheet, the punctures uniformly distributed across the sheet, each of the pinhole punctures having a diameter of between 0.0001 and 0.0005 inches; and a tab integral with the sheet and extending outwardly from the peripheral edge.

2. The apparatus of claim 1 wherein the tab has a tab thickness, the tab thickness lesser than a sheet thickness of the sheet.

3. The apparatus of claim 2 wherein the tab is coplanar with the front surface of the sheet.

4. The apparatus of claim 1 wherein the front surface is markable by a erasable marker ink.

5. The apparatus of claim 1 wherein the tab is formed so as to bend away from the rear surface of the sheet.

6. The apparatus of claim 1 further comprising an indicia on the front surface.

7. The apparatus of claim 6 wherein the indicia is printed onto the front surface.

8. The apparatus of claim 6 wherein the indicia is silk screened onto the front surface.
